(19) United States
(12) Patent Application Publication
(10) Pub. No.: US 2016/0253607 A1
(43) Pub. Date: Sep. 1, 2016

(54) Risk Measure-Based Decision Support Tool For Reservoir Development

(71) Applicant: Lu Xu, Pu Dong District (CN)

(72) Inventor: Lu Xu, Pu Dong District (CN)

(21) Appl. No.: 14/632,222

(22) Filed: Feb. 26, 2015

(51) Int. Cl. G06Q 10/06; E21B 41/00

(52) U.S. Cl. CPC G06Q 10/0635; E21B 41/0092

(57) ABSTRACT

A method including: obtaining, using a computer, a risk attitude of a decision maker for hydrocarbon development planning or resource management; obtaining, using the computer, data relevant to hydrocarbon development planning or resource management; selecting or developing, using the computer, a mathematical model that corresponds to the risk attitude of the decision maker; and processing the received data via the mathematical model; and generating a hydrocarbon development or management plan in response to processing the received data via the mathematical model.

### CROSS-REFERENCE TO RELATED APPLICATION

This application claims the benefit of U.S. Provisional Patent Application 61/951,385 filed Mar. 11, 2014 entitled RISK MEASURE-BASED DECISION SUPPORT TOOL FOR RESERVOIR DEVELOPMENT, the entirety of which is incorporated by reference herein.

### FIELD OF THE INVENTION

The present description relates generally to oil and gas production, and more particularly to work processes for reservoir evaluation, reservoir management, and/or reservoir development planning incorporating users' risk attitude.

### BACKGROUND

This section is intended to introduce various aspects of the art, which may be associated with the present technological advancement. This discussion is believed to assist in providing a framework to facilitate a better understanding of particular aspects of the present technological advancement. Accordingly, it should be understood that this section should be read in this light, and not necessarily as admissions of prior art.

Developing and managing petroleum resources often entails committing large economic investments over many years with an expectation of receiving correspondingly large financial returns. Whether a petroleum reservoir yields profit or loss depends largely upon the strategies and tactics implemented for reservoir development and management. Reservoir development planning involves devising and/or selecting strong strategies and tactics that will yield favorable economic results over the long term.

Reservoir development planning may include making decisions regarding size, timing, and location of facilities such as production platforms, FPSOs (floating production storage and offloading) vessels, subsea templates, wells, etc., as well as subsequent expansions and connections, for example. Additional key decisions can include the number, location, allocation to platforms, and timing of wells to be drilled and completed in each field. Post drilling decisions may include determining production or injection rate allocations across multiple wells and these decisions contribute significantly towards estimating or calculating financial returns. Any one decision or action may have system-wide implications, for example propagating positive or negative impact across a petroleum operation or a reservoir and consequently affecting profittability. In view of the aforementioned aspects of reservoir development planning, which are only a representative few of the many decisions facing a manager of petroleum resources, one can appreciate the value and impact of planning.

Currently, optimization modeling and solution technology are used to provide development planning decision support. Optimization of reservoir development planning and production can be affected by a number of factors and is difficult, even under the assumption that the behavior of fields involved is fully known. There are commonly a large number of soft and hard constraints, significant non-linearity due to reservoir behavior, and many continuous and discrete decisions to be made. FIG. 1 illustrates just some of the decision to be made during development planning relative to off shore development 100.

Consideration of uncertainty in reservoir properties and/or behaviors, prices, costs, facility start-up times, etc. can further challenge the decision support process as (1) there are many ways to model the optimization problem and (2) the solution of the resulting optimization model is extremely complicated and difficult. Uncertainties in reservoir properties, prices, cost, facility start-up times, etc. can be typically reduced to three cases—high-side (best possible outcome with a high value of a concerned uncertain quantity); most likely (average/expected outcome); and low-side (least favorable outcome with low numerical value of uncertain quantity). For instance, the uncertainty in reservoir behavior is reduced to a known value, for each of the three cases mentioned above, by typically sampling random points within the uncertainty space associated with the reservoir, then selecting three instances that yield oil recoveries in the 90th percentile, 50th percentile and 10th percentile, respectively. Uncertainty space, as used herein, generally refers to a representation of uncertainty relevant to a problem that is under consideration, for example the collective uncertainties for data input to an optimization routine.

Based upon limited sampling of the uncertainty space, a value is assigned to the “high-side” case, the “most-likely” or “mid” case, and the “low-side” case. Decisions are usually optimized for a specific case, usually the perceived “most-likely” case, and subsequently evaluated for the remaining two cases to provide an estimate of the level of risk. This approach, however, often greatly underestimates the complexity of the uncertainty and can lead to a solution that is sub-optimal or that is less favorable than some other unidentified solution.

### SUMMARY

A method including: obtaining, using a computer, a risk attitude of a decision maker for hydrocarbon development planning or resource management; obtaining, using the computer, data relevant to hydrocarbon development planning or resource management; selecting or developing, using the computer, a mathematical model that corresponds to the risk attitude of the decision maker; and processing the received data via the mathematical model; and generating a hydrocarbon development or management plan in response to processing the received data via the mathematical model.

### BRIEF DESCRIPTION OF THE DRAWINGS

While the present disclosure is susceptible to various modifications and alternative forms, specific examples thereof have been shown in the drawings and are herein described in detail. It should be understood, however, that the description herein of specific examples is not intended to limit the disclosure to the particular forms disclosed herein, but on the contrary, this disclosure is to cover all modifications and equivalents as defined by the appended claims. It should also be understood that the drawings are not necessarily to scale, emphasis instead being placed upon clearly illustrating principles of the present technological advancement. Moreover, certain dimensions may be exaggerated to help visually convey such principles.

FIG. 1 is an exemplary illustration of an off-shore development.

FIG. 2 is a schematic illustration of an example of a risk-based reservoir development planning system.

FIG. 3A illustrates an example of absolute semi-deviation as a risk measure.

FIG. 3B illustrates an example of expected regret as a risk measure.

FIG. 3C illustrates an example of maximum loss as a risk measure.

FIG. 3D illustrates an example of value at risk (VaR) as a risk measure.

FIG. 3E illustrates an example of a condition value at risk (CVaR) as a risk measure.

FIG. 4 illustrates a relationship among risk attitude, risk measures, and solutions.

FIG. 5 illustrates an exemplary computer system usable with the present technological advancement.

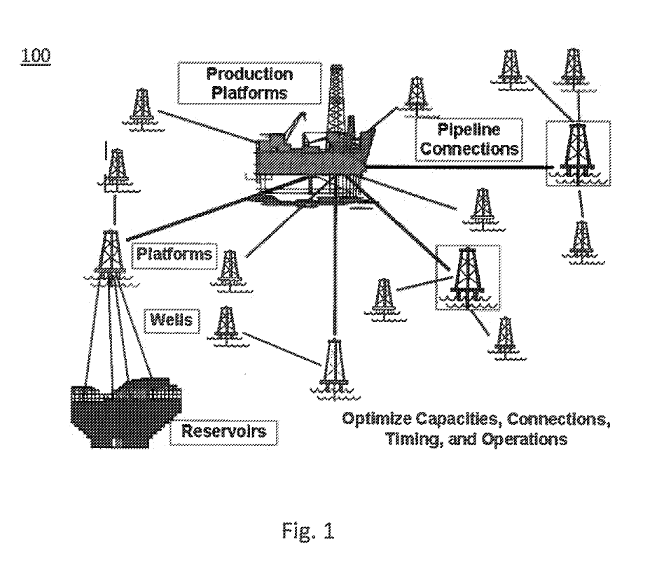

### DETAILED DESCRIPTION

Non-limiting examples of the present technological advancement are described herein. The invention is not limited to the specific examples described below, but rather, it includes all alternatives, modifications, and equivalents falling within the true spirit and scope of the appended claims.

Risk attitude is the way an individual or a group responds to various uncertain outcomes. In the context of oil-field development, significant capital investments are made to develop facilities, drill wells and manage resources. Uncertainty in reservoir properties, prices, costs, facility start-up times, etc., translates to uncertainty in revenue for the developed fields. The risk attitude quantitatively captures the decision maker's views on amount of capital invested with regards to uncertainty in the revenues. Broadly, risk attitudes can be classified into: risk-averse, risk-neutral or risk-seeking. The difference between the three broad attitudes can be explained by the following example. If offered either $50 or a 50% chance each of $100 and $0, a risk-neutral person would have no preference. In contrast, a risk averse person would prefer the first offer, while a risk seeking person would prefer the second.

Decisions can be significantly different based on the risk attitude of a decision-maker and this is illustrated by examples that follow. There is significant value in making the decision-maker's risk attitude available to the optimization model. This can be done either through inclusion of additional constraints or through modifications to the objective function. Markowitz's seminal work in the 1950s (Markowitz, H. M., “Portfolio Section”, The Journal of Finance 7 (1):, 77-91, March 1952, the entire content of which is hereby incorporated by reference) provides a risk-reward framework to quantitatively incorporate risk measure in decision making. Many variations of risk measures were developed since, and some are widely used in financial portfolio analysis and risk management, with value at risk (VaR), developed in 1990s, as a relatively recent example (see, Pavlo, Krokhmal, et al., “Modeling and Optimization of Risk, Surveys in Operations Research and Management Science, Vol. 16, Issue 2, July 2011, pp. 49-66, the entire contents of which is hereby incorporated by reference).

Previous patent documents (U.S. Pat. No. 8,504,335 and U.S. Patent Application Publications 2010/0325075, 2010/0332442, and 2011/0307230, the entire content of each these are hereby incorporated by reference) describe methods such as Stochastic Programming, Robust Optimization, and Markov Decision Process (MDP). Each of these methods incorporates a predetermined and embedded risk model. The present technological advancement further provides the flexibility to incorporate users' risk attitude by adjusting parameter(s). Non-limiting examples of the paramters that can be adjusted include: parameters that control choice of risk measures in a composite objective or constraint; parameters that control calculation of risk measures e.g. predefined target values that go into calculating expected regret; parameters that control balance between expected performance and risk.

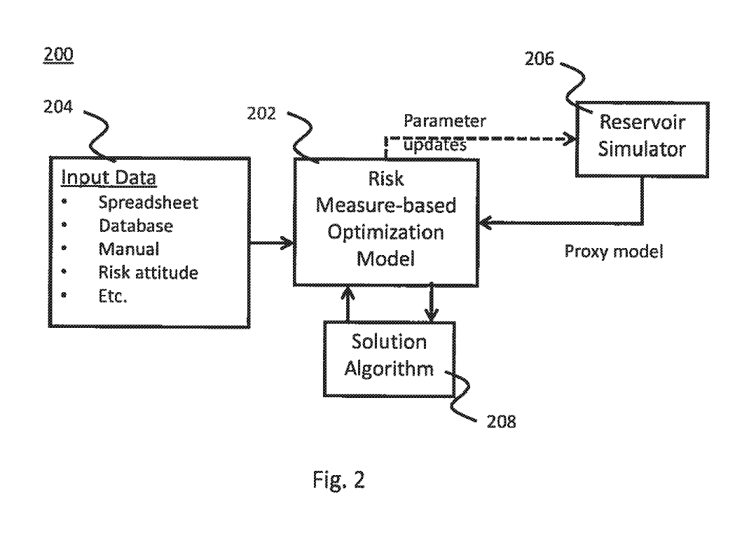

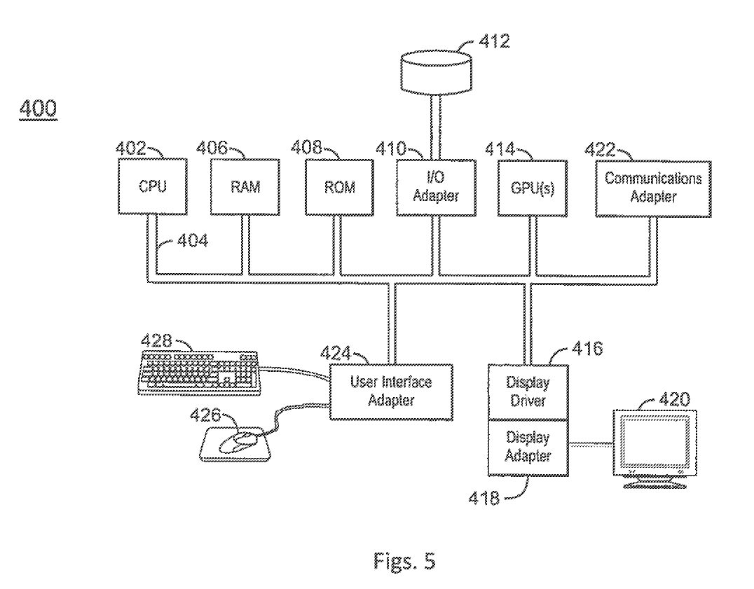

The present technological advancement may be an optimization-based decision support tool for development planning and management of petroleum resources, which explicitly requires the decision-maker's risk attitude. FIG. 2 is a schematic illustration of a risk-based reservoir development planning system 200. The reservoir development planning system 200, as discussed in more detail below, may be implemented with one or more computers (see, FIG. 5).

The risk-based reservoir development planning system 200 can include a complete list of risk models 202 that represent various risk attitudes and provide customized solutions. An appropriate model that corresponds to the user's risk attitude can be selected or developed. It is important to note that uncertainties and the user's risk attitude can be considered as a part of the risk model (and consequently be reflected in the decisions) rather than exploring effects through scenarios. Both discrete and continuous distributions for the realizations of uncertainty can be employed. The mathematical model with the selected or developed risk model is then solved and the output is used to generate reports, calculations, tables, figures, charts, etc. for the analysis of development planning or reservoir management under data uncertainty.

By way of explanation, three categories of risk measure-based models will be described. However, the present technological advancement is not limited to these three categories. Three categories of risk measure-based models includes: a mean-risk model which represents flexible risk attitude; an upside gain model which is risk prone; and a risk-averse model, such as regret model.

### Mean Risk Model

A mean-risk model has as its objective function the expected performance plus a scaled measure of risk, where the scale can be tuned to represent users' attitude toward risk, and is hence flexible. Mean-risk models were developed in early fifties for the portfolio selection problem. In his seminal work “Portfolio selection”, Markowitz (1952) proposed variance as a risk measure. Since then, many alternative risk measures have been proposed.

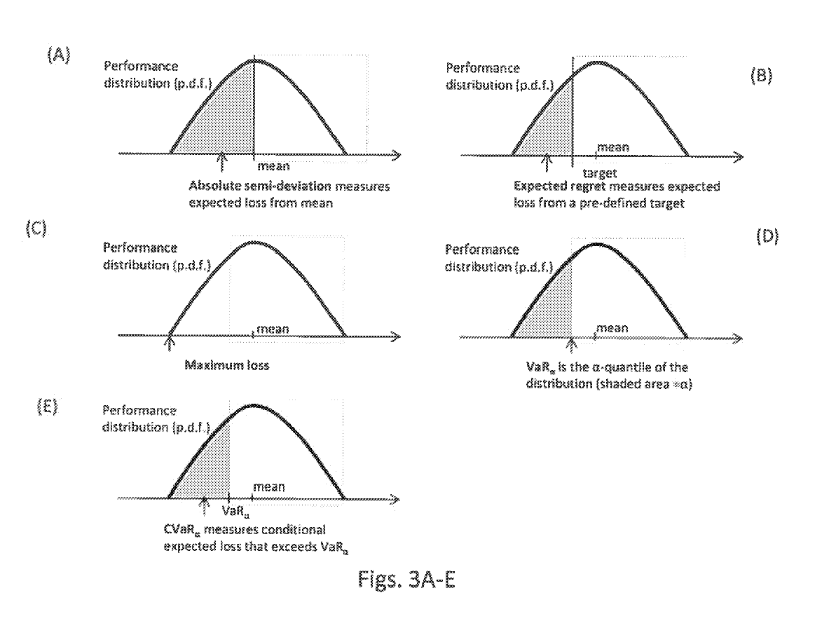

Risk measures can be based on downside moments of performance distribution to reflect asymmetric risk preferences. Such risk measures include central semi-moments (e.g., absolute semi-deviation is first-order central semi-moments), lower partial moments (e.g., expected regret from a pre-specified target is the first-order lower partial moment), maximum loss or worst case risk, VaR (value at risk), and conditional value at risk (CVaR). Typical downside risk measures are summarized in FIGS. 3A-E and are explained below.

FIG. 3A illustrates absolute semi-deviation as a risk measure. Absolute semi-deviation measures expected loss from mean. In other words, the absolute semi-deviation measures a probability (over all realizations of uncertainty) of encountering a metric (e.g. profit, revenue, etc.) below an average/mean value of the metric.

FIG. 3B illustrates expected regret as a risk measure. Expected regret measures a probability (over all realizations of uncertainty) of encountering a metric (e.g. profit, revenue, etc.) below a pre-defined target value of the metric. In FIG. 3B, the target is below the mean. However, any target could be set.

FIG. 3C illustrates maximum loss as a risk measure. Maximum loss measures a worst-case value of the metric. In some situations, values of zero or less for the metric can be disregarded. For example, for the metric of profit, the worst-case value can be taken as the lowest value above zero.

FIG. 3D illustrates value at risk (VaR). Given a pre-specified probability or chance, the corresponding VaR is the value of the metric such the probability of encountering a metric below the VaR is equal to the pre-specified probability.

FIG. 3E illustrates a condition value at risk measure (CVaR). The CVaR, at a prespecified probability or chance (% p), is the expected value of the metric in the worst % p of the possible outcomes.

### Upside Gain Model

An upside gain model optimizes performance of the system in optimistic cases and is risk prone. This model works the best for a problem where upside gain dominates downside loss. Upside gain is measured based on upside moments of the performance distribution. An example of an upside gain model is maximum upside among all solutions.

### Regret Model

A regret model minimizes regret or opportunity loss, which is defined as the difference between system performances and the best attainable performance under each scenario, either in maximum or expected sense.

For a minimum regret model, regret for a particular solution is defined as maximum (over all scenarios) difference between the best outcome of the metric (i.e., best profit) from any other solution and the outcome of the metric (i.e., best profit) from the particular solution. The user, if seeking to minimize regret, would select the particular solution with the lowest maximum regret.

Other regret models can be used with the present technological advancement.

### Input Data

The risk measured-based optimization model can receive data from input data 204. The input data 204 can comprise data entries in one or more spreadsheets, one or more databases, manual entries, information fed over a computer network or the Internet, user input through a graphical user interface (GUI), and the risk attitude of the decision maker.

### Optimization

The risk measured-based optimization model 202 interfaces with solution algorithm 200. The solution algorithm 208 can comprise one or more routines, methods, processes, or algorithms for solving the risk measured-based optimization model 202. Decisions are made based on the solutions generated by an optimizer that factors/considers the risk-measure metrics. It is expected that the optimization model for development planning can include discrete and continuous decisions and may include linear and/or nonlinear constraints either for modeling reservoir behavior or for incorporating risk measures.

A discrete variable is a decision variable that takes only discrete values. For example, a decision regarding the installation of a floating production, storage and offloading (FSPO) unit (a floating vessel used in the oil and gas industry for processing hydrocarbons) is binary; installed or not installed. Installed can be given a value of 0 and not installed can be given a value of 1. Another example of a discrete decision variable is in what year a compartment/reservoir is to be opened (year 1, year 2, year 3, year 4, . . . etc.).

A continuous variable is a decision variable that can take any value in a specified range. For example, a flow rate of oil from a compartment can take any non-negative value, or FPSO size can take any value between its' maximum size and zero.

A linear constraint is a relationship between decision variables (discrete and continuous) in which the decision variables appear linearly. For example, the sum of oil and water capacity decision variables should be less than or equal to maximum liquid capacity, or total oil flow from a field is equal to the sum of flows from all compartments/reservoirs in that field.

A nonlinear constraint is a relationship between decision variables (discrete and continuous) in which not all the decision variables appear linearly. For example, gas rate from a compartment/reservoir is equal to the product of gas-oil ratio and oil rate for that compartment.

The solution of the underlying mathematical representation of the specific business problem may be obtained using commercial mathematical programming solver algorithms (CPLEX, Gurobi). However, those of ordinary skill in the art know that other solution algorithms can be employed to solve the underlying mathematical representation, or can apply heuristics to arrive at an approximate solution. A person of ordinary skill in the art will recognize that particular solution algorithms may be problem dependent, and can select the best means to solve the problem.

An option in developing an algorithm to solve the underlying mathematical problem is to consider whether the full uncertainty space needs to be considered or if sample points from the uncertainty space are sufficient. The full uncertainty space can be represented as a range of possible values. For example, a compartment/reservoir may be thought to have between 1,000,000 and 1,000,000,000 barrels of oil. Another example is the price of oil. When development and planning decisions are made, the future price of oil is uncertain, and could range between $40 to $150 per barrel. In order to reduce complexity, sample points within these ranges could be used, wherein the sample points are thought to be representative of the full uncertainty space.

The choice regarding sampling is partly driven by the nature of the constraints in the optimization model. If all constraints are linear, then for certain risk measure-based objectives, the full uncertainty space can potentially be considered and an equivalent deterministic model can be developed to solve the problem. For problems with non-linear constraints and general risk measures, one approach would be to employ sample-based solution methods. A methodology for solving such sample-based models would be to decompose the model into subproblems and optimize each subproblem separately and use the subproblem solution to infer a feasible solution for the original model.

As discussed above, the underlying mathematical problem can be constructed as an optimization problem. The present technological advancement can include a plurality of generic optimization models that are data independent mathematical representations of the problems under consideration and can deal with a variety of risk measures.

### Reservoir Simulator

Once a solution to the mathematical problem is found, parameter updates (i.e., some or all of a reservoir development plan) for the reservoir simulator 206 may be generated based on the solution of the optimization model and the reservoir simulator 206 may be evaluated at this solution. The parameter updates (feedback from the optimization model 202 to the reservoir simulator 206) allows proxy models to be customized for the decisions produced by the optimization model. The details will of course depend on the decisions included in the model and the assumptions being made. The model may produce both developmental decisions such as the number and location of wells, as well as operational decisions such as workover timing and type and well choke and valve settings. Then the simulation can be run over the uncertainty space with these updated decisions - which may depend on uncertainties that have been resolved at that point in time - to provide improved proxy models. The results may then be validated against the prediction of the optimization model and may be used to generate revised constraints. If the results from the optimization model are consistent with the reservoir simulator results, the process may stop. Otherwise, new constraints may be generated for the reservoir and surface facility behavior and an optimization model may be updated and solved again in continuation of the process.

The reservoir simulator can comprise or be based on upon software based tools, programs, or capabilities, such as those marketed by: (1) Schlumberger Technology Corporation under the registered trademark “ECLIPSE”, (2) Landmark Graphics Corporation under the registered trademark “VIP”, or (3) Landmark Graphics Corporation under the registered trademark “NEXUS”.

### Example

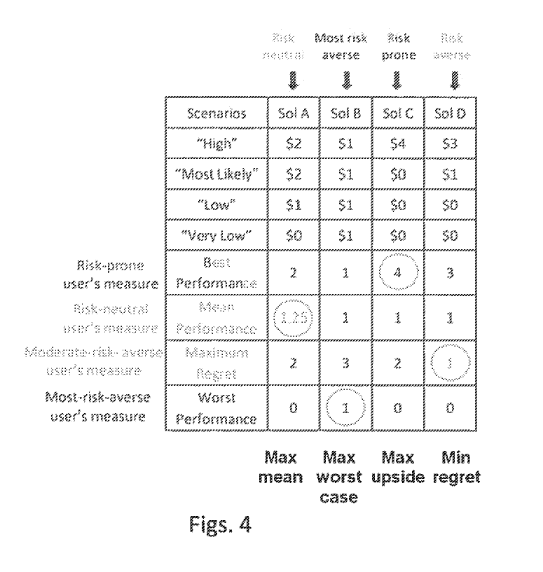

FIG. 4 illustrates a relationship among risk attitude, risk measures, and solutions. FIG. 4 provides an example of how risk-based reservoir development planning system 200 determines a decision based on a user's risk attitude.

In the example of FIG. 4, all potential alternatives/solutions for a development planning exercise are known apriori. In a typical setting, not all of the options are known apriori, and the optimization algorithm determines a solution based on the risk model. For purposes of explaining a non-limiting application of the present technological advancement, it will be assumed that the alternatives are known and four alternative solutions are denoted by Sol. A, Sol. B, Sol. C and Sol. D. In this example, there is reservoir uncertainty and the outcome of this uncertainty can be at one of four levels: high, medium, low, and very low. It is assumed that these four outcomes are equally likely.

The net present value (NPV) for each of the alternative solutions at each of the four levels of uncertainty is presented in FIG. 4. If the user is extremely risk-prone, then the present technological advancement can pick an upside gain model (or max upside, where upside gains dominate downside losses), and propose that the user pick an alternative that has the highest best case NPV. In the context of FIG. 4, the present technological advancement would suggest going with Sol. C as it offers the highest rewards/best performance ($4) over any other alternative considered over all levels of sub-surface uncertainty. For a risk neutral decision maker, the present technological advancement could offer mean/average performance over uncertainty levels as a metric, and in the context of the data in FIG. 4, the tool would select Sol. A as it has the highest value of mean (average over four uncertainty levels) performance ($1.25). For a moderately risk-averse user, the present technological advancement could offer a minimum regret model, where regret (actually maximum regret) for a particular solution is defined as maximum (over all scenarios) difference between the best profit from any other solution and the profit from the particular solution. In the case of FIG. 4, the maximum regret over all four solutions is for Sol. D ($1) and consequently a moderately risk-averse decision maker can choose this solution. An extremely risk-averse person can choose to make a decision based on the best worst-case (over all scenarios) performance. The worst-case profit for each of the cases is shown in FIG. 4 and in this case Sol. B has the best worst-case profit. These examples illustrate that the decision maker's best alternative could be completely different based on his/her risk attitude and this also illustrates the benefit of the present technological advancement that incorporates the decision makers risk attitude while making development planning and resource management decisions.

### Computer Hardware

FIG. 5 is a block diagram of a computer system 400 that can be used to execute an the present techniques. A central processing unit (CPU) 402 is coupled to system bus 404. The CPU 402 may be any general-purpose CPU, although other types of architectures of CPU 402 (or other components of exemplary system 400) may be used as long as CPU 402 (and other components of system 400) supports the operations as described herein. Those of ordinary skill in the art will appreciate that, while only a single CPU 402 is shown in FIG. 8, additional CPUs may be present. Moreover, the computer system 400 may comprise a networked, multi-processor computer system that may include a hybrid parallel CPU/GPU system. The CPU 402 may execute the various logical instructions according to various teachings disclosed herein. For example, the CPU 402 may execute machine-level instructions for performing processing according to the operational flow described.

The computer system 400 may also include computer components such as non-transitory, computer-readable media. Examples of computer-readable media include a random access memory (RAM) 406, which may be SRAM, DRAM, SDRAM, or the like. The computer system 400 may also include additional non-transitory, computer-readable media such as a read-only memory (ROM) 408, which may be PROM, EPROM, EEPROM, or the like. RAM 406 and ROM 408 hold user and system data and programs, as is known in the art. The computer system 400 may also include an input/output (I/O) adapter 410, a communications adapter 422, a user interface adapter 424, and a display adapter 418.

The I/O adapter 410 may connect additional non-transitory, computer-readable media such as a storage device(s) 412, including, for example, a hard drive, a compact disc (CD) drive, a floppy disk drive, a tape drive, and the like to computer system 400. The storage device(s) may be used when RAM 406 is insufficient for the memory requirements associated with storing data for operations of the present techniques. The data storage of the computer system 400 may be used for storing information and/or other data used or generated as disclosed herein. For example, storage device(s) 412 may be used to store configuration information or additional plug-ins in accordance with an the present techniques. Further, user interface adapter 424 couples user input devices, such as a keyboard 428, a pointing device 426 and/or output devices to the computer system 400. The display adapter 418 is driven by the CPU 102 to control the display on a display device 420 to, for example, present information to the user regarding available plug-ins.

The architecture of system 400 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” includes a hardware processor (such as those found in the hardware devices noted above), ASICs, and VLSI circuits. Input data to the computer system 400 may include various plug-ins and library files. Input data may additionally include configuration information.

The present techniques may be susceptible to various modifications and alternative forms, and the examples discussed above have been shown only by way of example. However, the present techniques are not intended to be limited to the particular examples disclosed herein. Indeed, the present techniques include all alternatives, modifications, and equivalents falling within the spirit and scope of the appended claims.

What is claimed is:

1. A method comprising:
obtaining, using a computer, a risk attitude of a decision maker for hydrocarbon development planning or resource management;
obtaining, using the computer, data relevant to hydrocarbon development planning or resource management;
selecting or developing, using the computer, a mathematical model that corresponds to the risk attitude of the decision maker; and
processing the received data via the mathematical model; and
generating a hydrocarbon development or management plan in response to processing the received data via the mathematical model.

2. The method according to claim 1, wherein the risk attitude is selected from a set of predetermined mathematical models.

3. The method of claim 2, wherein the set of predetermined mathematical models includes at least a mean risk model, an upside gain model, and a risk adverse model.

4. The method of claim 1, wherein the selecting or developing is based on the risk attitude of the decision maker and a net present value assigned to each of a plurality of options that are each associated with plural levels of uncertainty.

5. The method according to claim 1, further comprising:
producing hydrocarbons from a reservoir according to the hydrocarbon development or management plan.

6. A non-transitory computer readable storage medium encoded with instructions, which when executed by a computer causes the computer to implement method comprising:
obtaining, using a computer, a risk attitude of a decision maker for hydrocarbon development planning or resource management;
obtaining, using the computer, data relevant to hydrocarbon development planning or resource management;
selecting or developing, using the computer, a mathematical model that corresponds to the risk attitude of the decision maker; and
processing the received data via the mathematical model; and
generating a hydrocarbon development or management plan in response to processing the received data via the mathematical model.

7. The non-transitory computer readable medium of claim 6, wherein the risk attitude is selected from a set of predetermined mathematical models.

8. The non-transitory computer readable medium of claim 7, wherein the set of predetermined mathematical models includes at least a mean risk model, an upside gain model, and a risk adverse model.

9. The non-transitory computer readable medium of claim 6, wherein the selecting or developing is based on the risk attitude of the decision maker and a net present value assigned to each of a plurality of options that are each associated with plural levels of uncertainty.

10. The non-transitory computer readable medium of claim 6, wherein the method further comprisies:
producing hydrocarbons from a reservoir according to the hydrocarbon development or management plan.
